(19) United States
(12) Patent Application Publication
(10) Pub. No.: US 2025/0269760 A1
(43) Pub. Date: Aug. 28, 2025

(54) VEHICLE-TO-GRID COMMUNICATION COMPLIANCE FOR ELECTRIC VEHICLES

(71) Applicant: Atieva, Inc., Newark, CA (US)

(72) Inventors: Rohan Desai, Newark, CA (US); Nate Foss, Newark, CA (US)

(21) Appl. No.: 18/590,832

(22) Filed: Feb. 28, 2024

(51) Int. Cl. B60L 55/00; B60L 53/66; H04L 12/42

(52) U.S. Cl. CPC B60L 55/00; B60L 53/66; H04L 12/42; B60L 2210/40

(57) ABSTRACT

In some embodiments, an electric vehicle (EV) comprises energy storage; a device to receive power to charge the energy storage and to send power from the energy storage to an electrical power grid, where the device includes an inverter to convert DC power from the energy storage to AC power to be sent into the electrical power grid; on-board communication hardware; and one or more processors to send and receive communications, using the communication hardware and according to interoperability requirements of the electric utility company, related to discharging power from the energy storage to the electrical power grid.

### FIELD

Embodiments disclosed herein relate generally to automobiles, and more particularly, to vehicle-to-grid communication compliance for an electric vehicle (EV).

### BACKGROUND

Electric vehicles (EVs) offer a promising alternative to traditional combustion engine vehicles, and often integrate smart technology and safety features into their designs. EVs are often charged though an electric vehicle supply equipment (EVSE) charger that provides power to the EV. When an EV is plugged into the EVSE, there's a communication process before charging begins. For example, the EVSE communicates with the EV to determine the amount of power it can provide and then requests an amount of power to be provided that the EV can accept. The power that is provided via the EVSE is usually from an electric utility grid under control of an electric utility company and is done via a process that follows one or more standards.

There are a number of technologies that enable the supply of power to an electrical power grid. These technologies operate according to one or more industry standards that have been developed. One such standard, IEEE 1547-2018, refers to a standard developed by the Institute of Electrical and Electronics Engineers (IEEE) to integrate distributed energy resources (DERs) into the electric distribution grid, and includes specifications for the interconnection between utility electric power systems (EPSs) and distributed energy resources (DERs).

### SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In some embodiments, an electric vehicle (EV) comprises energy storage; a device to receive power to charge the energy storage and to send power from the energy storage to an electrical power grid, where the device includes an inverter to convert DC power from the energy storage to AC power to be sent to the electrical power grid; on-board communication hardware; and one or more processors to send and receive communications, using the communication hardware and according to interoperability requirements of the electric utility company, related to discharging power from the energy storage to the electrical power grid.

### BRIEF DESCRIPTION OF THE DRAWINGS

The appended drawings illustrate examples and are, therefore, exemplary embodiments and not considering to be limiting in scope.

FIG. 1 illustrates some embodiments of a communication framework for use by an EV in communicating with an electric utility company in compliance with the electric utility interconnection requirements.

FIG. 2 is a dataflow diagram of a process for controlling an electric vehicle (EV).

FIG. 3 shows a communication framework with a mobile (e.g., EV) vehicle and an electric utility company.

FIG. 4 is a high-level view of some embodiments of a vehicle 400.

FIG. 5 is a high-level illustration of an exemplary computing device that can be used in accordance with the systems and methodologies disclosed herein.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Apparatuses and methods for using on-board communication hardware and protocols on an electric vehicle (EV) that meet the interconnection requirements of an electric utility company to communicate with that electric utility company are disclosed. In some embodiments, the electric utility interconnection requirements are specified by one or more industry standards. In some embodiments, the communications between the EV and the electric utility company are related to vehicle-to-grid energy (e.g., power, voltage, etc.) transfers from the EV to an electric utility grid. In some embodiments, the vehicle-to-grid transfers from the EV to an electrical power grid involve discharge power (current) from an energy storage (e.g., one or more batteries, a battery pack, etc.) of the EV to the electrical power grid, and the communication between the electric utility company and the EV is related to, and/or facilitates and/that process.

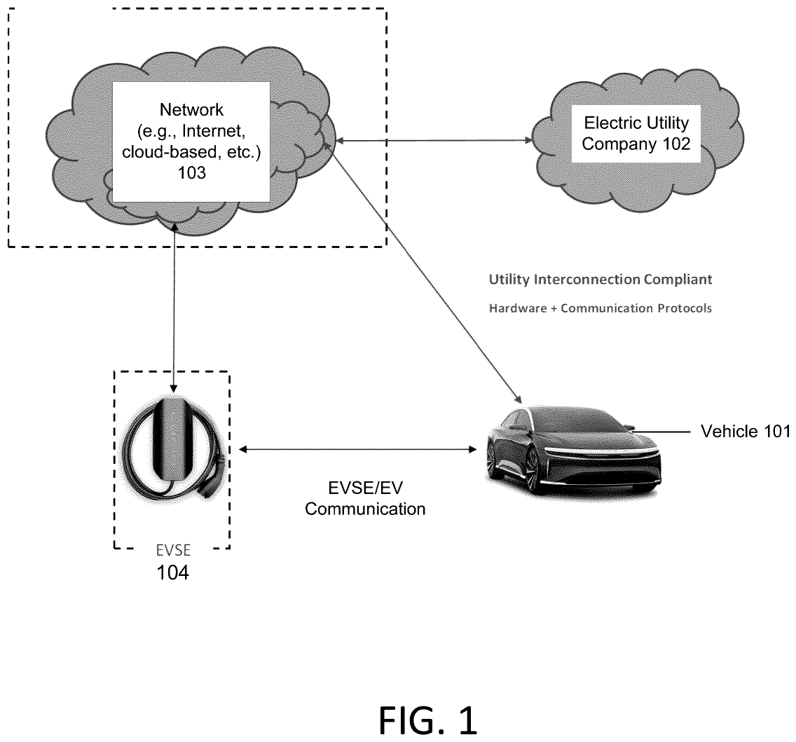

FIG. 1 illustrates some embodiments of a communication framework for an EV to communicate with an electric utility company in compliance with the electric utility interconnection requirements related to vehicle-to-grid energy transfers. Referring to FIG. 1, a mobile vehicle 101 and an electric utility 102 are communicably coupled to a network 103. In some embodiments, the communications between mobile vehicle 101 and electric utility company 102 are sent through network 103. Network 103 can include a cloud-based communication network (e.g., cloud-based communications).

In some embodiments, mobile vehicle 101 comprises an EV. In some embodiments, mobile vehicle 101 includes energy storage (e.g., one or more batteries, a battery pack, etc.), a charging port electrically coupled to the energy storage to transfer power to and from the energy storage, an inverter to generate voltage to be sent into an electrical power grid, on-board communication hardware and protocols, and one or more processors. The processor(s) exchange communications with electric utility company 102, using the communication hardware and according to interoperability requirements of electric utility company 102. Because the communications meet the interoperability requirements of electric utility company 102, the communication hardware and protocols of mobile vehicle 101 are considered utility interconnection compliant. In some embodiments, the communications related to the interoperability requirements occur between the communication hardware and the electric utility company without going through the charging port.

In some embodiments, the communications with electric utility company 102 and mobile vehicle 101 are related to discharging voltage from the EV's energy storage to the electrical power grid. That is, mobile vehicle 101 operates as an energy storage system that has vehicle-to-grid capability to discharge energy into the electrical power grid (i.e., grid discharge capability).

In some embodiments, mobile vehicle 101 has an inverter to support the vehicle-to-grid capability to discharge energy into the electrical power grid. As mobile vehicle 101 moves to different portions of the electrical power grid, its inverter becomes a mobile inverter that is able to provide power to those different portions of the grid. In some embodiments, the communications with electric utility company 102 include inverter settings associated with the inverter of mobile vehicle 101. The inverter settings can be site specific based on the portion of the electrical grid to which mobile vehicle 101 is connected. In some embodiments, the communications with electric utility company 102 meet utility interconnection requirements for stationary inverter based generation via the IEEE 1547-2018 Standard. In some embodiments, the inverter settings for the stationary inverter are the optimal settings as per the IEEE 1547-2018 Standard. In some embodiments, the inverter settings are given during an interconnection approval process, but can change during operation. Such a change can be due to an interconnection agreement.

In some embodiments, the communication hardware and protocols used by mobile vehicle 101 to meet the interconnection requirements of the electric utility comprise a communication gateway and a communication physical layer. In some embodiments, the communication physical layer comprises an Ethernet communication system layer with an Ethernet interface and communications related to the interoperability requirements occur via the Ethernet interface. In some embodiments, the Ethernet communication system comprises an Ethernet Ring that transfers communications related to vehicle-to-grid operations according to the interoperability requirements of the electric utility company as well as communications related to other non-vehicle-to-grid related communications of the EV. In some embodiments, the non-vehicle-to-grid related communications comprise communications related to one or more subsystems of mobile vehicle 101, such as, for example, a driver-assistance system of mobile vehicle 101.

In some embodiments, mobile vehicle 101 is charged using a charger, such as by EVSE 104. In some embodiments, the energy storage (e.g., batteries, etc.) of mobile device 101 can be charged when EVSE 104 is plugged into, or otherwise electrically connected to, the charging port of mobile vehicle 101. In some embodiments, when EVSE 104 is plugged into, or otherwise electrically connected to, the charging port of mobile device 101, EV communications with the charger occur. These communications can determine the amount of power a charger can provide and can includes requests for an amount of power to be provided to mobile vehicle 101. In some embodiments, these communications occur over a HomePlug Green-PHY Power Line Carrier. Note that any communications between EVSE 104 and mobile vehicle 101 are not related to the vehicle-to-grid discharging power (current) from the EV's energy storage to the electrical power grid and they are not associated with the interoperability requirements of the electric utility company related to that capability.

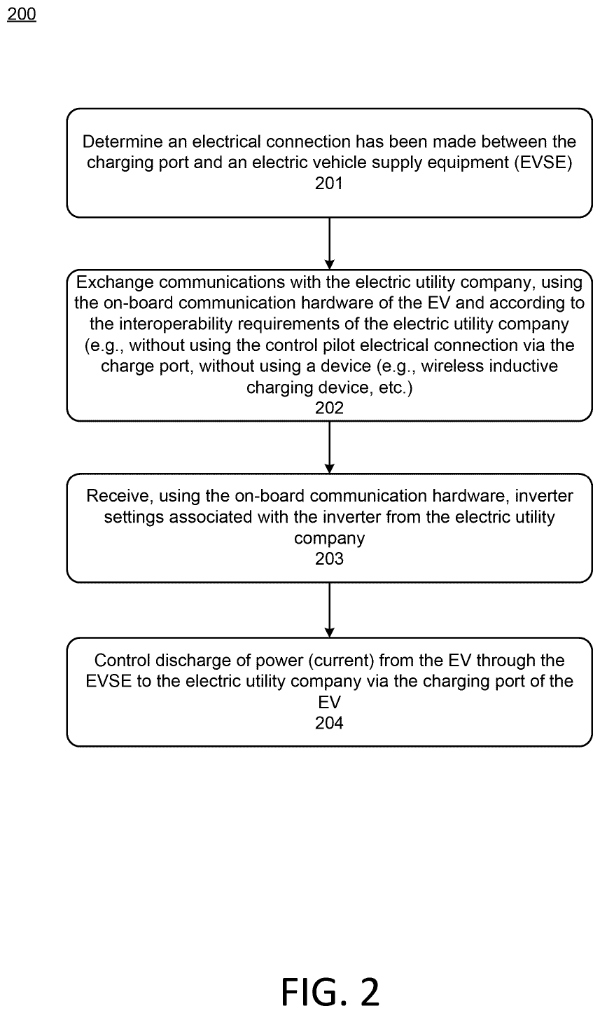

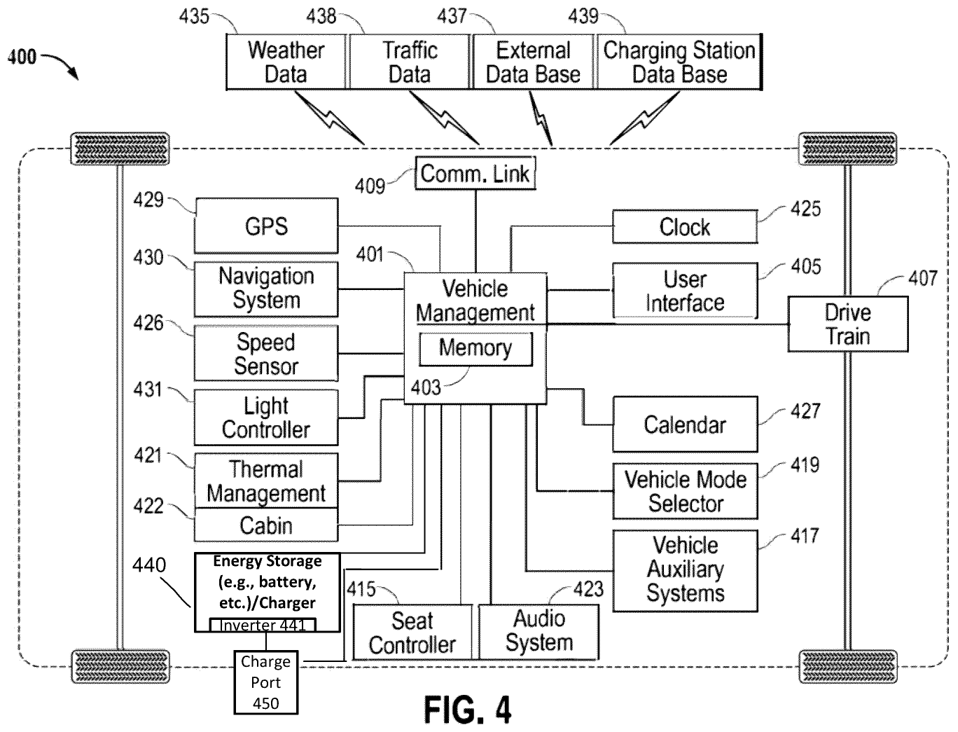

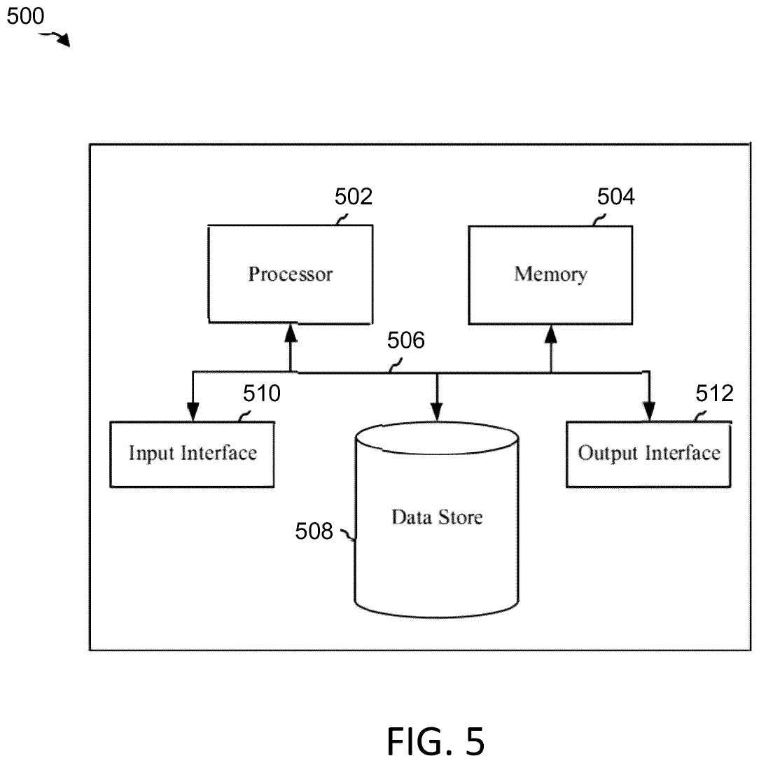

FIG. 2 is a dataflow diagram of a process for controlling an electric vehicle (EV). In some embodiments, the EV has one or more batteries (e.g., a battery pack), a charging port electrically coupled to the one or more batteries to transfer power to and from the one or more batteries, and an inverter suitable for injecting into an electrical power grid. In some embodiments, the inverter can inject power into the grid via the charging port. The method can be performed by processing logic that may comprise hardware (e.g., circuitry, dedicated logic, programmable logic, a processor, a processing device, a CPU, a system-on-chip, etc.), software (e.g., instructions running/executing on a processing device), firmware (e.g., microcode), or a combination thereof. In some embodiments, at least a portion of the method may be performed by portions of the EV of FIG. 4 and computing device of FIG. 5.

Referring to FIG. 2, the process includes processing logic determining that an electrical connection has been made between the charging port and an electric vehicle supply equipment (EVSE) or other suitable power transfer cable or other means (block 201). The electrical connection can be the result of a user coupling the plug of the EVSE into the EV vehicle's charging port receptacle.

After the electrical connection has been made between the charging port and the EVSE, processing logic exchanges communications with the electric utility company, using the on-board communication hardware of the EV and according to the interoperability requirements of the electric utility company, without using the control pilot electrical connection via the charge port (block 202). In some embodiments, the communications are related to discharging power from the one or more batteries of the EV to the electrical power grid. In some embodiments, the exchange of communication between the EV and the electric utility company using the on-board communication hardware (without using the control pilot electrical connection via the charge port) occurs after a negotiation between the EV and the EVSE through the charging port. The exchange of communications can include the EV sending communications to and receiving communications from the electric utility company and vice versa.

In some embodiments, communications related to the interoperability requirements occur between the communication hardware and the electric utility company using cloud-based communication. In some embodiments, the communication hardware comprises an Ethernet communication system with an Ethernet interface and communications related to the interoperability requirements occur via the Ethernet interface. In some embodiments, the Ethernet communication system comprises an Ethernet Ring that transfers communications related to the interoperability requirements of the electric utility company and communications related to other non-power related communications of the EV.

In some embodiments, the communications related to the interoperability requirements complies with an Inverter-based Generation DER Standard. In some embodiments, the Inverter-based Generation DER Standard is Institute of Electrical and Electronics Engineers (IEEE) 1547-2018.

In some embodiments, the process also includes processing logic receiving, using the on-board communication hardware, inverter settings associated with the inverter from the electric utility company (block 203). As discussed above, the inverter is suitable for injecting into an electrical power grid. To that end, the inverter is able to output direct current (DC) that is sent via the charging port of the EV through an EVSE or suitable power transport mechanism to an electric utility company (e.g., power receiving and/or transfer facility, etc.). In some embodiments, the inverter converts direct current (DC) into an alternating current (AC), or vice versa for purposes of providing power. In some embodiments, this operation is included in the exchange of communications described in block 203 above.

After receiving the inverter settings, processing logic controls the discharge of power (current) from the EV through the EVSE to the electric utility company via the charging port of the EV (processing block 204).

Note that in some other embodiments, the EV does not include a charge port and includes another device to facility the transfer of power to and from its on-board storage device (e.g., batteries). For example, in some embodiments, the EV uses wireless inductive charging to charge its storage device and the device would include a charging coil or other part that facilitates the transfer of power to and from the storage device, as opposed to a charge point and its electrical connection.

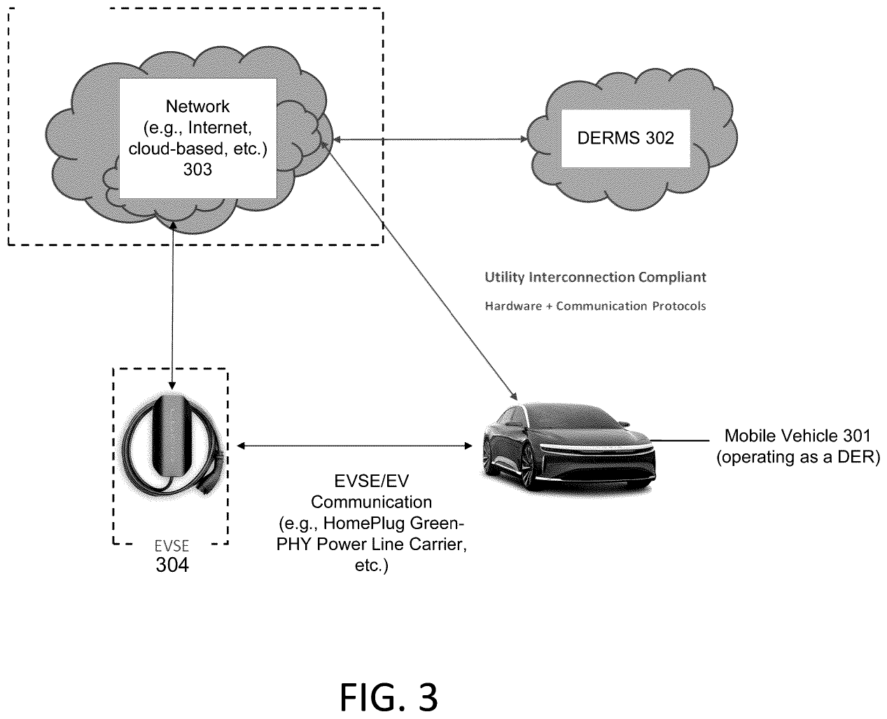

In some embodiments, an EV (e.g., mobile vehicle 101) with an inverter and vehicle-to-grid discharge capability to discharge energy into the electrical power grid operates as a distributed energy resources (DER) system. In some embodiments, mobile vehicle 301 can operate as an interconnectable DER when stationary in park and electrically plugged in via the vehicle charging port to a power source such as, for example, an EVSE (e.g., EVSE 304). FIG. 3 shows a communication framework with a mobile (e.g., EV) vehicle and an electric utility company. Referring to FIG. 3, mobile vehicle 301 is a DER having a DER interface to communicate with a utility distributed energy resource management system (DERMS) 302 that manages a group of distributed energy resource (DER) system. In some embodiments, these communications occur via a network 303.

In some embodiments, the DER interface of mobile vehicle 301 includes a communication stack to handle communications with the electric utility company. The communication stack can be part of a telematics control unit (TCU) of mobile vehicle 301. In some embodiments, the communications are related to the interoperability requirements and comply with an Inverter-based Generation DER Standard. In some embodiments, the Inverter-based Generation DER Standard is Institute of Electrical and Electronics Engineers (IEEE) 1547-2018. In some embodiments, the communication stack includes protocols that enable an interface to an Ethernet communication network (e.g., an Ethernet Ring, etc.), and an associated Ethernet port, of mobile vehicle 301 as described above for DER communications related to vehicle-to-grid operations.

FIG. 4 is a high-level view of some embodiments of a vehicle 400. Vehicle 400 can be an electric vehicle (EV), a vehicle utilizing an internal combustion engine (ICE), or a hybrid vehicle, where a hybrid vehicle utilizes multiple sources of propulsion including an electric drive system. Vehicle 400 includes a vehicle on-board system controller 401, also referred to herein as a vehicle management system, which is comprised of one or more processors (e.g., a central processing unit (CPU)). System controller 401 also includes memory 403, with memory 403 being comprised of EPROM, EEPROM, flash memory, RAM, solid state drive, hard disk drive, or any other type of memory or combination of memory types.

In some embodiments, vehicle 400 includes one or more internal networks by which system controller 401 interfaces and communicates with one or more internal subsystems of vehicle 400. System controller 401 can also use the one or more internal networks to transfer communications to and from external locations. In some embodiments, the one or more internal networks can be communicably coupled to one or more networks through a network interface. The network interface can provide for wired and/or wireless communication. When used in a local area networking environment (or a wide area networking environment), the network interface can include an Ethernet interface and the one or more internal networks includes an Ethernet communication network (e.g., an Ethernet Ring, etc.) with an Ethernet Port. Other possible embodiments use other communication devices. For example, in some embodiments vehicle 400 includes a modem for communicating across an internal network and/or with an external network.

In some embodiments, vehicle 400 includes a charging port 450 and one or more batteries (e.g., battery pack, etc.)/battery charger as an energy storage system 440 that provides power to portions of vehicle 400. The charging port 450 is used for providing voltage to vehicle 400 for charging the energy storage system 440 (e.g., charging batteries of batteries/charger by the use of, for example, an EVSE or other power source in a manner well-known in the art. The charging port 450 can be used to transfer power from a battery of the energy storage system 440 to an external location as part of a vehicle-to-grid power transfer. In some embodiments, charging port 450 includes a communication path for communications between the system controller 401 and the locations external to vehicle 400 such as, for example, the power source providing power (voltage) to vehicle 400 for charging batteries of the energy storage system 440 and a utility distributed energy resource management system (DERMS) or an electric utility company and its facilities.

In some embodiments, energy storage system 440 includes an inverter that generates voltage for transfer to an electric power grid. In some embodiments, the inverter converts DC voltage to AC voltage for transfer to the electric power grid. In some embodiments, the same inverter (or a separate invertor) converts DC voltage to AC voltage for charging a battery of the energy storage system 440 or can provide DC to AC voltage conversion when providing power to an electrical power grid as part of a vehicle-to-grid operation.

In some embodiments, vehicle 100 includes a user interface 405 is coupled to vehicle management system 401. Interface 405 allows the driver, or a passenger, to interact with the vehicle management system, for example inputting data into the navigation system 430, altering the heating, ventilation and air conditioning (HVAC) system via the thermal management system 421, controlling the vehicle's entertainment system (e.g., radio, CD/DVD player, etc.), adjusting vehicle settings (e.g., seat positions, light controls, etc.), and/or otherwise altering the functionality of vehicle 400. In some embodiments, user interface 405 also includes means for the vehicle management system to provide information to the driver and/or passenger, information such as a navigation map or driving instructions (e.g., via the navigation system 430 and GPS system 429) as well as the operating performance of any of a variety of vehicle systems (e.g., battery pack charge level for an EV, fuel level for an ICE-based or hybrid vehicle, selected gear, current entertainment system settings such as volume level and selected track information, external light settings, current vehicle speed (e.g., via speed sensor 426), current HVAC settings such as cabin temperature and/or fan settings, etc.) via the thermal management system 421. Interface 405 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Vehicle 400 can also include other features like an internal clock 425 and a calendar 427.

In some embodiments, user interface 405 includes one or more interfaces including, for example, a front dashboard display (e.g., a cockpit display, etc.), a touch-screen display (e.g., a pilot panel, etc.), as well as a combination of various other user interfaces such as push-button switches, capacitive controls, capacitive switches, slide or toggle switches, gauges, display screens, warning lights, audible warning signals, etc. It should be appreciated that if user interface 405 includes a graphical display, controller 401 may also include a graphical processing unit (GPU), with the GPU being either separate from or contained on the same chip set as the processor.

Vehicle 400 also includes a drive train 407 that can include an internal combustion engine, one or more motors, or a combination of both. The vehicle's drive system can be mechanically coupled to the front axle/wheels, the rear axle/wheels, or both, and may utilize any of a variety of transmission types (e.g., single speed, multi-speed) and differential types (e.g., open, locked, limited slip).

Drivers often alter various vehicle settings, either when they first enter the car or while driving, in order to vary the car to match their physical characteristics, their driving style and/or their environmental preferences. System controller 401 monitors various vehicle functions that the driver may use to enhance the fit of the car to their own physical characteristics, such as seat position (e.g., seat position, seat height, seatback incline, lumbar support, seat cushion angle and seat cushion length) using seat controller 415 and steering wheel position using an auxiliary vehicle system controller 417. In some embodiments, system controller 401 also can monitor a driving mode selector 419 which is used to control performance characteristics of the vehicle (e.g., economy, sport, normal). In some embodiments, system controller 401 can also monitor suspension characteristics using auxiliary vehicle system 417, assuming that the suspension is user adjustable. In some embodiments, system controller 401 also monitors those aspects of the vehicle which are often varied by the user in order to match his or her environmental preferences for the cabin 422, for example setting the thermostat temperature or the recirculation controls of the thermal management system 421 that uses an HVAC controller, and/or setting the radio station/volume level of the audio system using controller 423, and/or setting the lights, either internal lighting or external lighting, using light controller 431. Also, besides using user-input and on-board sensors, system controller 401 can also use data received from an external on-line source that is coupled to the controller via communication link 409 (using, for example, GSM, EDGE, UMTS, CDMA, DECT, WiFi, WiMax, etc.). For example, in some embodiments, system controller 401 can receive weather information using an on-line weather service 435 or an on-line data base 437, traffic data 438 for traffic conditions for the navigation system 430, charging station locations from a charging station database 439, etc. In some embodiments, communication link 409 comprises an Ethernet communication link with an Ethernet Port for external communications.

The system controller 401 can transfer information with the components described above over one or more internal networks, such as those, for example, described above. In some embodiments, the system controller 401 is communicably coupled to one or more of these components via an Ethernet communication network (e.g., an Ethernet Ring, etc.). The Ethernet communication network can be used to transfer other data such as data related to, but not limited to, one or more of a driver-assistance system, telematics, over-the-air updates, etc.

FIG. 5 is a high-level illustration of an exemplary computing device 500 that can be used in accordance with the systems and methodologies disclosed herein. For instance, the computing device 500 may be or include the vehicle 400 of FIG. 4. The computing device 500 includes at least one processor 502 that executes instructions that are stored in a memory 504. The instructions may be, for instance, instructions for implementing functionality described as being carried out by one or more modules or instructions for implementing one or more of the methods described above. The processor 502 may access the memory 504 by way of a system bus 506.

The computing device 500 additionally includes a data store 508 that is accessible by the processor 502 by way of the system bus 506. The data store 508 may include executable instructions and the like. The computing device 500 also includes an input interface 510 that allows external devices to communicate with the computing device 500. For instance, the input interface 510 may be used to receive instructions from an external computing device, from a user, etc. The computing device 500 also includes an output interface 512 that interfaces the computing device 500 with one or more external devices. In some embodiment, the input interface 510 and the output interface 512 can be used to communicate to an electric utility company (e.g., a utility distributed energy resource management system (DERMS) or server, etc.). These communications can relate to vehicle-to-grid operations and/or standards as described above. In some embodiment, the input interface 510 and the output interface 512 are part of, or communicably coupled to, an Ethernet port of an Ethernet communication network (e.g., an Ethernet Ring, etc.).

Additionally, while illustrated as a single system, it is to be understood that the computing device 500 may be a distributed system. Thus, for instance, several devices may be in communication by way of a network connection and may collectively perform tasks described as being performed by the computing device 500.

There are a number of example embodiments described herein.

Example 1 is an electric vehicle (EV) that includes an energy storage; a device to receive power to charge the energy storage and to send power from the energy storage to an electrical power grid, the device including an inverter to convert DC power from the energy storage to AC power to be sent into the electrical power grid; on-board communication hardware; and one or more processors to send and receive communications, using the communication hardware and according to interoperability requirements of the electric utility company, related to discharging power from the energy storage to the electrical power grid.

Example 2 is the EV of example 1 that may optionally include a distributed energy resources (DER) interface comprising a communication stack to handle communication with the electric utility company.

Example 3 is the EV of example 2 that may optionally include that the communication related to the interoperability requirements complies with an inverter-based generation DER Standard.

Example 4 is the EV of example 3 that may optionally include that the Inverter-based Generation DER Standard is Institute of Electrical and Electronics Engineers (IEEE) 1547-2018.

Example 5 is the EV of any of examples 1-4 that may optionally include that communications with the electric utility company include inverter settings associated with the inverter.

Example 6 is the EV of any of examples 1-5 that may optionally include that communications related to the interoperability requirements occur between the communication hardware and the electric utility company without going through the charging port.

Example 7 is the EV of any of examples 1-6 that may optionally include that communications related to the interoperability requirements occur between the communication hardware and the electric utility company using cloud-based communication.

Example 8 is the EV of any of examples 1-7 that may optionally include that the communication hardware comprises an Ethernet communication system with an Ethernet interface and communications related to the interoperability requirements occur via the Ethernet interface.

Example 9 is the EV of example 8 that may optionally include that the Ethernet communication system comprises an Ethernet Ring that transfers communications related to the interoperability requirements of the electric utility company and communications related to other non-power related communications of the EV.

Example 10 is the EV of example 9 that may optionally include that the non-power related communications comprise communications related to one or more of telematics, over-the-air updating, and a driver-assistance system.

Example 11 is the EV of any of examples 1-10 that may optionally include that the device comprises a charging port or wireless charging device and the communication occurs without using the electrical connection and going through the device.

Example 12 is a method for controlling an electric vehicle (EV) having one or more batteries, a device electrically coupled to the one or more batteries to transfer power to and from the one or more batteries, and an inverter suitable for injecting into an electrical power grid, the method includes: determining that the device on the EV for transferring power to and from the one or more batteries is in position to transfer power with an electric vehicle supply equipment (EVSE); and sending and receiving communications, to and from, respectively, the electric utility, using the on-board communication hardware of the EV and according to interoperability requirements of the electric utility company, the electric utility company related to discharging DC power from the one or more batteries to the electrical power grid, without using the electrical connection and going through the device.

Example 13 is the method of example 12 that may optionally include that the EV comprises an inverter, and the method further includes receiving, using the on-board communication hardware, inverter settings associated with the inverter from the electric utility company.

Example 14 is the method of any of examples 12-13 that may optionally include that the communications related to the interoperability requirements complies with an inverter-based generation DER standard.

Example 15 is the method of example 14 that may optionally include that the Inverter-based Generation DER Standard is Institute of Electrical and Electronics Engineers (IEEE) 1547-2018.

Example 16 is the method of any of examples 12-15 that may optionally include that communications related to the interoperability requirements occur between the communication hardware and the electric utility company using cloud-based communication.

Example 17 is the method of any of examples 12-16 that may optionally include that the communication hardware comprises an Ethernet communication system with an Ethernet interface and communications related to the interoperability requirements occur via the Ethernet interface.

Example 18 is the method of example 17 that may optionally include that the Ethernet communication system comprises an Ethernet Ring that transfers communications related to the interoperability requirements of the electric utility company and communications related to other non-power related communications of the EV.

Example 19 is the method of any of examples 12-18 that may optionally include that sending and receiving communications, to and from, respectively, the electric utility, using the on-board communication hardware of the EV and according to interoperability requirements of the electric utility company is without going through a control pilot electrical connection via a charge port on the EV.

Example 20 is an article of manufacture having one or more non-transitory computer readable media storing instructions which, when executed by an electronic device, cause the electronic device to perform a method that includes: determining that the device on the EV for transferring power to and from the one or more batteries is in position to transfer power with an electric vehicle supply equipment (EVSE); and exchanging, using the on-board communication hardware of the EV, communications with the electric utility company related to discharging power from the one or more batteries to the electrical power grid according to interoperability requirements of the electric utility company, without using the electrical connection and going through the device.

Example 21 is the article of manufacture of example 20 that may optionally include that the EV comprises an inverter, and further comprising receiving, using the on-board communication hardware, inverter settings associated with the inverter from the electric utility company.

Example 22 is the article of manufacture of example 20 that may optionally include that the communication hardware comprises an Ethernet Ring with an Ethernet interface that is used by the EV for communications related to other non-power related communications of the EV and communications related to the interoperability requirements occur via the Ethernet interface.

Example 23 is an apparatus including means for implementing a method in any of Examples 1-22.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in some embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

We claim:

1. An electric vehicle (EV) comprising:
an energy storage;
a device to receive power to charge the energy storage and to send power from the energy storage to an electrical power grid, the device including an inverter to convert DC power from the energy storage to AC power to be sent into the electrical power grid;
on-board communication hardware; and
one or more processors to send and receive communications, using the communication hardware and according to interoperability requirements of the electric utility company, related to discharging power from the energy storage to the electrical power grid.

2. The EV of claim 1 further comprising a distributed energy resources (DER) interface comprising a communication stack to handle communication with the electric utility company.

3. The EV of claim 2 wherein the communication related to the interoperability requirements complies with an inverter-based generation DER Standard.

4. The EV of claim 3 wherein the Inverter-based Generation DER Standard is Institute of Electrical and Electronics Engineers (IEEE) 1547-2018.

5. The EV of claim 1 wherein communications with the electric utility company include inverter settings associated with the inverter.

6. The EV of claim 1 wherein communications related to the interoperability requirements occur between the communication hardware and the electric utility company without going through the charging port.

7. The EV of claim 1 wherein communications related to the interoperability requirements occur between the communication hardware and the electric utility company using cloud-based communication.

8. The EV of claim 1 wherein the communication hardware comprises an Ethernet communication system with an Ethernet interface and communications related to the interoperability requirements occur via the Ethernet interface.

9. The EV of claim 8 wherein the Ethernet communication system comprises an Ethernet Ring that transfers communications related to the interoperability requirements of the electric utility company and communications related to other non-power related communications of the EV.

10. The EV of claim 9 wherein the non-power related communications comprise communications related to one or more of telematics, over-the-air updating, and a driver-assistance system.

11. The EV of claim 1 wherein the device comprises a charging port or wireless charging device and the communication occurs without using the electrical connection and going through the device.

12. A method for controlling an electric vehicle (EV) having one or more batteries, a device electrically coupled to the one or more batteries to transfer power to and from the one or more batteries, and an inverter suitable for injecting into an electrical power grid, the method comprising:
determining that the device on the EV for transferring power to and from the one or more batteries is in position to transfer power with an electric vehicle supply equipment (EVSE); and
sending and receiving communications, to and from, respectively, the electric utility, using the on-board communication hardware of the EV and according to interoperability requirements of the electric utility company, the electric utility company related to discharging DC power from the one or more batteries to the electrical power grid, without using the electrical connection and going through the device.

13. The method of claim 12 wherein the EV comprises an inverter, and further comprising:
receiving, using the on-board communication hardware, inverter settings associated with the inverter from the electric utility company.

14. The method of claim 12 wherein the communications related to the interoperability requirements complies with an inverter-based generation DER standard.

15. The method of claim 14 wherein the Inverter-based Generation DER Standard is Institute of Electrical and Electronics Engineers (IEEE) 1547-2018.

16. The method of claim 12 wherein communications related to the interoperability requirements occur between the communication hardware and the electric utility company using cloud-based communication.

17. The method of claim 12 wherein the communication hardware comprises an Ethernet communication system with an Ethernet interface and communications related to the interoperability requirements occur via the Ethernet interface.

18. The method of claim 17 wherein the Ethernet communication system comprises an Ethernet Ring that transfers communications related to the interoperability requirements of the electric utility company and communications related to other non-power related communications of the EV.

19. The method of claim 12 wherein sending and receiving communications, to and from, respectively, the electric utility, using the on-board communication hardware of the EV and according to interoperability requirements of the electric utility company is without going through a control pilot electrical connection via a charge port on the EV.

20. An article of manufacture having one or more non-transitory computer readable media storing instructions which, when executed by an electronic device, cause the electronic device to perform a method comprising:
determining that the device on the EV for transferring power to and from the one or more batteries is in position to transfer power with an electric vehicle supply equipment (EVSE); and
exchanging, using the on-board communication hardware of the EV, communications with the electric utility company related to discharging power from the one or more batteries to the electrical power grid according to interoperability requirements of the electric utility company, without using the electrical connection and going through the device.

21. The article of manufacture of claim 20 wherein the EV comprises an inverter, and further comprising receiving, using the on-board communication hardware, inverter settings associated with the inverter from the electric utility company.

22. The article of manufacture of claim 20 wherein the communication hardware comprises an Ethernet Ring with an Ethernet interface that is used by the EV for communications related to other non-power related communications of the EV and communications related to the interoperability requirements occur via the Ethernet interface.
